(19) United States
(12) Patent Application Publication
(10) Pub. No.: US 2015/0254130 A1
(43) Pub. Date: Sep. 10, 2015

(54) ERROR CORRECTION DECODER

(71) Applicant: Kabushiki Kaisha Toshiba, Minato-ku (JP)

(72) Inventors: Kenji SAKAUE, Yokohama-shi (JP); Kouji Saitou, Tokyo (JP); Tatsuyuki Ishikawa, Yokohama-shi (JP); Kazuhiro Ichikawa, Yamato-shi (JP); Naoaki Kokubun, Yokohama-shi (JP); Hironori Uchikawa, Yokohama-shi (JP)

(73) Assignee: Kabushiki Kaisha Toshiba, Minato-ku (JP)

(21) Appl. No.: 14/200,736

(22) Filed: Mar. 7, 2014

(51) Int. Cl. G06F 11/10

(52) U.S. Cl. CPC G06F 11/1068

(57) ABSTRACT

According to an embodiment, an error correction decoder includes a first calculation circuit and a second calculation circuit. The first calculation circuit and the second calculation circuit perform the column processing based on the second reliability information corresponding to variable nodes belonging to each of one or more valid blocks arranged in a first row group and the row processing based on the first reliability information corresponding to variable nodes belonging to one or more valid blocks arranged in a second row group whose processing order is later than that of the first row group in parallel.

### CROSS-REFERENCE TO RELATED APPLICATIONS

This application claims the benefit of U.S. Provisional Application No. 61/911,115, filed Dec. 3, 2013, the entire contents of which are incorporated herein by reference.

### FIELD

Embodiments described herein relate generally to decoding of an error-correcting code.

### BACKGROUND

An error-correcting code has been used to correct an error in read data from, for example, a nonvolatile semiconductor memory such as a NAND memory. An LDPC (Low Density Parity Check) code as a kind of error-correcting code is known for its high error-correcting capabilities. It is also known that decoding performance of the LDPC code improves in proportion to the length of a codeword. For example, the length of a codeword adopted for a NAND flash memory is on the order of 10 kilobits.

The reliability of NAND read data is typically quantized to 5 or 6 bits in the form of a logarithm likelihood ratio (LLR). That is, a memory (LMEM) to store an LLR of NAND read data needs a large capacity of the codeword length×number of quantization bits. From the viewpoint of cost optimization, therefore, LMEM is generally implemented by using SRAM (Static Random Access Memory). Therefore, assuming implementation of a general LDPC decoder for a NAND memory, the calculation algorithm and hardware thereof are optimized. For example, an LDPC decoder is designed based on a block-based parallel processing scheme that collectively performs memory access to an LLR stored in LMEM using continuous addresses.

### BRIEF DESCRIPTION OF THE DRAWINGS

FIG. 1 is a block diagram exemplifying an error correction decoder of a block-based parallel processing scheme;

FIG. 2 exemplifies a parity check matrix;

FIG. 3 exemplifies a Tanner graph corresponding to the parity check matrix in FIG. 2;

FIG. 4A exemplifies the parity check matrix in which a plurality of blocks is arranged;

FIG. 4B exemplifies a numeric value allocated to each block of FIG. 4A;

FIG. 5A is an explanatory view of partially parallel processing in block units;

FIG. 5B is an explanatory view of the partially parallel processing in block units;

FIG. 6A is an explanatory view of the partially parallel processing in block units;

FIG. 6B is an explanatory view of the partially parallel processing in block units;

FIG. 6C is an explanatory view of the partially parallel processing in block units;

FIG. 7 is a flow chart exemplifying error correction decoding processing of the block-based parallel processing scheme;

FIG. 8 exemplifies the order of performing row processing and column processing in a block-based parallel processing scheme;

FIG. 9 is a block diagram exemplifying an error correction decoder according to a first embodiment;

FIG. 10 is a block diagram exemplifying an operation of an error correction decoder according to a first embodiment;

FIG. 11 is a diagram exemplifying the parity check matrix satisfying constraints described in the first embodiment;

FIG. 12 is a diagram exemplifying the parity check matrix not satisfying constraints described in the first embodiment;

FIG. 13 is an explanatory view of scheduling done by the error correction decoder according to the first embodiment; and

FIG. 14 is a block diagram exemplifying the operation of the error correction decoder according to a second embodiment.

### DETAILED DESCRIPTION

The description of embodiments will be provided below with reference to the drawings. The same or similar symbols are attached to elements that are the same or similar to described elements to basically omit a duplicate description.

According to an embodiment, an error correction decoder includes a first storage unit, a second storage unit, a first calculation circuit and a second calculation circuit. The first storage unit stores first reliability information of each of a plurality of bits corresponding to an ECC (Error Correction Code) frame defined by a parity check matrix in which M×N (M and N are integers equal to 2 or greater) blocks are arranged, each of the blocks corresponding to either an invalid block as a zero matrix of p rows×p columns (p is an integer equal to 2 or greater) or a valid block as a nonzero matrix of p rows×p columns. The second storage unit stores second reliability information of each of the plurality of bits. The first calculation circuit reads the first reliability information corresponding to variable nodes belonging to each of one or more valid blocks arranged in a given row group of the parity check matrix from the first storage unit, calculates the second reliability information corresponding to the variable nodes by performing row processing based on the first reliability information, and writes the second reliability information to the second storage unit. The second calculation circuit reads the second reliability information corresponding to variable nodes belonging to each of the one or more valid blocks arranged in the given row group of the parity check matrix from the second storage unit, calculates the first reliability information corresponding to the variable nodes by performing column processing based on the second reliability information, and writes the first reliability information to the first storage unit. The first calculation circuit and the second calculation circuit perform the column processing based on the second reliability information corresponding to variable nodes belonging to each of one or more valid blocks arranged in a first row group and the row processing based on the first reliability information corresponding to variable nodes belonging to one or more valid blocks arranged in a second row group whose processing order is later than that of the first row group in parallel.

### First Embodiment

An LDPC code is defined by a parity check matrix. An error correction decoder typically corrects an error in LDPC coded data by performing iterative decoding using the parity check matrix.

In general, the row of a parity check matrix is called a check node and the column of a parity check matrix is called a variable node (or a bit node). The row weight means the total number of nonzero elements contained in a row of interest and the column weight means the total number of nonzero elements contained in a column of interest. In a parity check matrix defining a so-called regular LDPC code, the row weight of each row is common and the column weight of each column is also common.

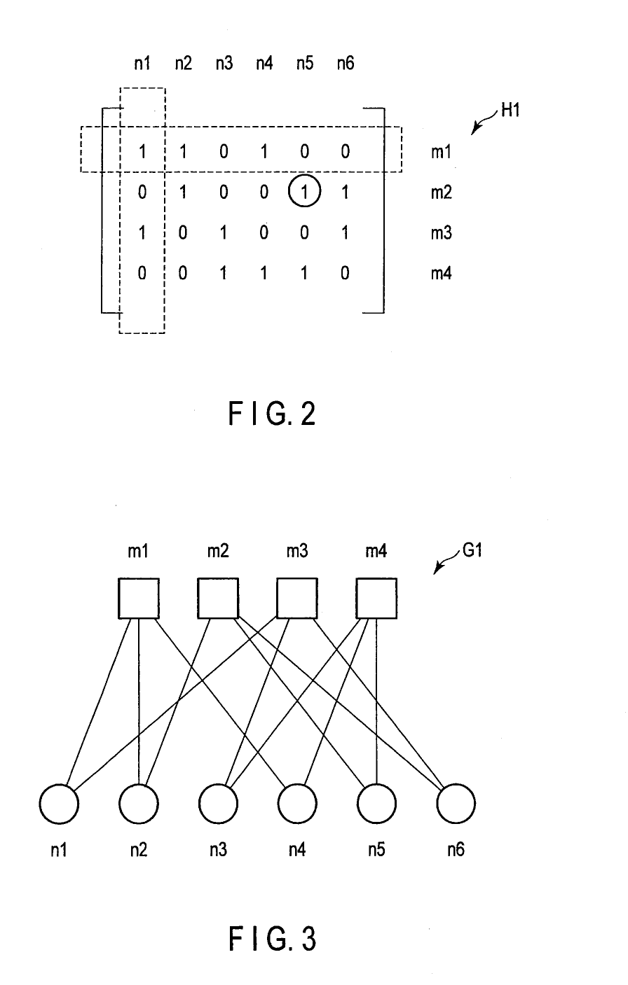

A parity check matrix H1 is exemplified in FIG. 2. The size of the parity check matrix H1 is 4 rows×6 columns. The four rows of the parity check matrix H1 are each called, for example, check nodes m1, . . . , m4. Similarly, the six columns of the parity check matrix H1 are each called, for example, variable nodes n1, . . . , n6. The row weight of all rows of the parity check matrix H1 is 3 and the column weight of all columns of the parity check matrix H1 is 2. The parity check matrix H1 defines a (6, 2) LDPC code. The (6, 2) LDPC code means an LDPC code of the codeword length=6 bits and the information length=2 bits.

A parity check matrix can be represented as a 2-part graph called a Tanner graph. More specifically, a variable node and a check node corresponding to a nonzero element in the parity check matrix are connected by an edge. That is, the total number of edges connected to a variable node is equal to the column weight of the variable node and the total number of edges connected to a check node is equal to the row weight of the check node.

The parity check matrix H1 in FIG. 2 can be represented as a Tanner graph G1 in FIG. 3. For example, an element corresponding to a variable node n5 and a check node m2 is nonzero in the parity check matrix H1 and therefore, the variable node n5 and the check node m2 are connected by an edge in the Tanner graph G1.

In iterative decoding (ITR), a temporary estimated word is generated based on reliability information of each of a plurality of bits forming an LDPC frame. If the temporary estimated word satisfies a parity check, decoding terminates normally, but if the temporary estimated word does not satisfy a parity check, decoding continues. More specifically, update processing of reliability information called row processing and column processing is performed for all check nodes and variable nodes in each trial of iterative decoding to re-generate a temporary estimated word based on the updated reliability information. If the temporary estimated word does not satisfy the parity check even if the trial count of iterative decoding reaches a predetermined upper limit, decoding is generally forced to terminate (abnormal termination). In the description that follows, iterative decoding means trying to iteratively perform a sequence of processing including all row processing and column processing of a parity check matrix, generation of a temporary estimated word, and parity checks of temporary estimated words for all check nodes.

As the reliability information, reliability information α (called, for example, an extrinsic value or extrinsic information) propagated from a check node to a variable node via an edge and reliability information β (called, for example, an a priori probability, a posteriori probability, probability, or LLR) propagated from a variable node to a check node via an edge are used. Further, a channel value λ depending on read data (or a received signal) corresponding to a variable node is used to calculate the reliability information α and the reliability information β.

Iterative decoding is performed based on, for example, the Sum-Product algorithm, the Min-Sum algorithm or the like. Iterative decoding based on these algorithms can be realized by parallel processing.

However, completely parallel processing in which all processing is parallelized needs a large number of calculation circuits. Specifically, the number of calculation circuits needed for completely parallel processing depends on the length of an LDPC codeword and thus, when the length of an LDPC codeword is long, completely parallel processing is not realistic.

According to so-called partially parallel processing, on the other hand, the circuit scale can be reduced. To realize partially parallel processing, typically M×N (M and N are natural numbers) blocks are arranged in a parity check matrix. Each of these blocks corresponds to a valid block (that is, an identity matrix of p (p is an integer equal to 2 or greater and is also called a block size) rows×p columns or a cyclic shift matrix of the identity matrix of p rows×p columns) or an invalid block (that is, a zero matrix of p rows×p columns). Partially parallel processing on such a parity check matrix can be realized by p calculation circuits regardless of the length of an LDPC codeword.

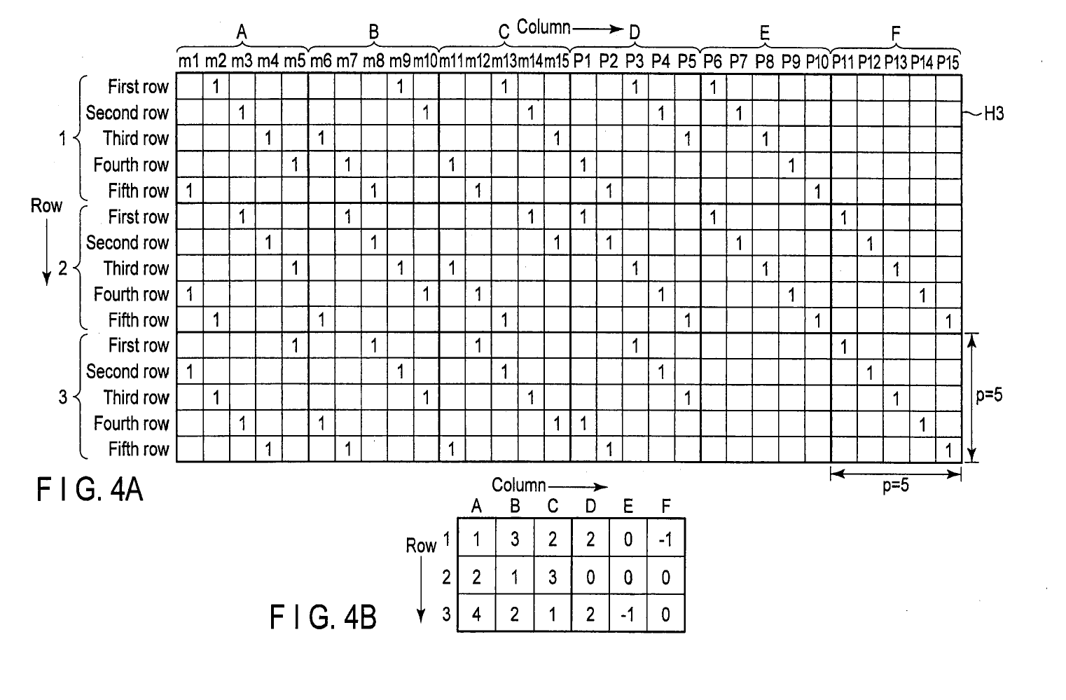

In partially parallel processing, for example, a parity check matrix shown in FIG. 4A is adopted. In the parity check matrix in FIG. 4A, a plurality of blocks of the block size=5 are arranged. The row size of the parity check matrix is 3 blocks (=15 rows) and the column size thereof is 6 blocks (=30 rows). Each block in FIG. 4A is an identity matrix of 5 rows×5 columns, a cyclic shift matrix of the identity matrix of 5 rows×5 columns, or a zero matrix of 5 rows×5 columns. According to the parity check matrix in FIG. 4A, the number of calculation circuits needed for partially parallel processing is five.

Each block in FIG. 4A can be represented, as exemplified in FIG. 4B, by a numeric value. In FIG. 4B, “0” is given to an identity matrix, a shift value (right direction) is given to a cyclic shift matrix, and “−1” is given to a zero matrix. The identity matrix can be considered as a cyclic shift matrix of the shift value=0. In general, a block of the block size=p can be represented by “−1”, “0”, . . . , “p−1”. A calculation circuit obtains the extrinsic value α and the a priori/a posteriori probability β by inputting an LMEM variable (or called also LLR) and a TMEM variable and performing an calculation based on the above inputs. The LMEM variable is a variable to derive the a priori/a posteriori probability β for each variable node. The TMEM variable is a variable to derive the extrinsic value α for each check node.

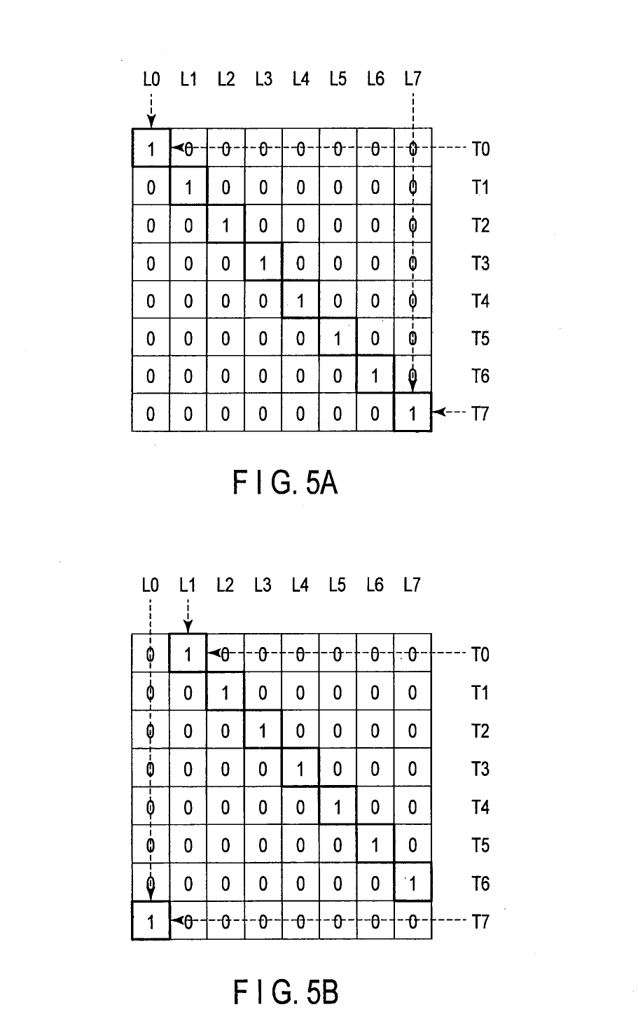

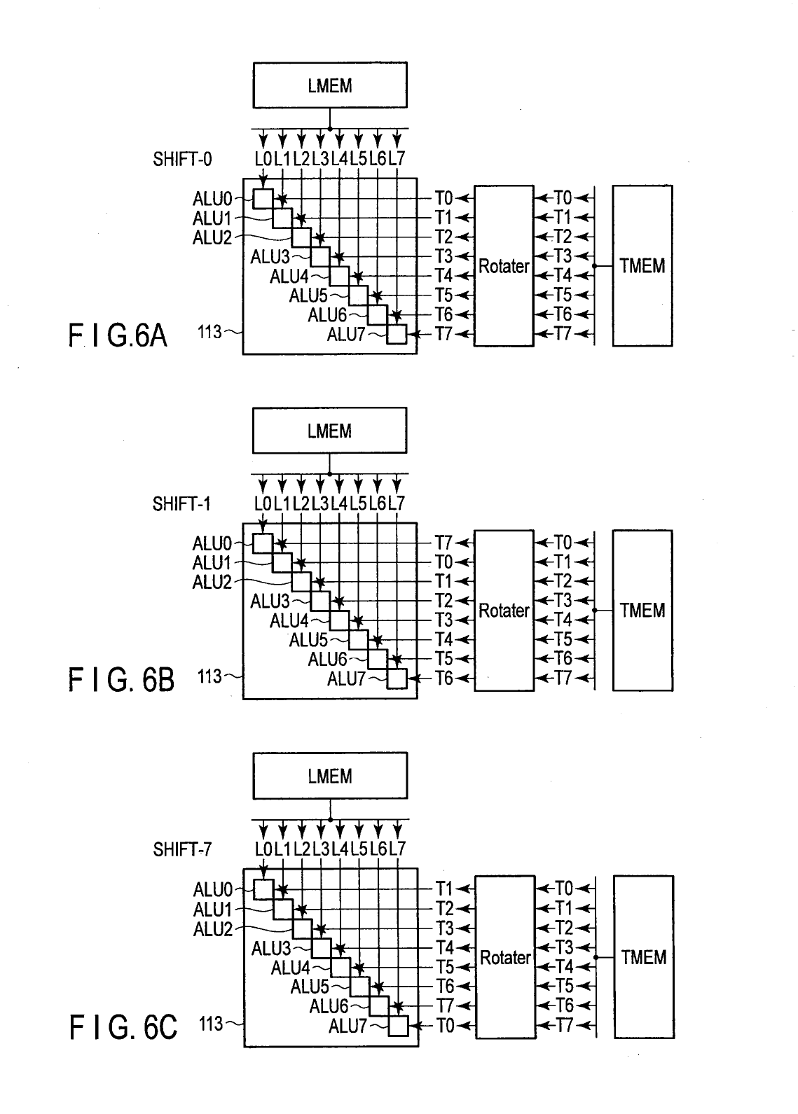

In partially parallel processing, input variables of calculation circuits are controlled in accordance with the shift value of a valid block. For example, as shown in FIGS. 5A, 5B, 6A, 6B, and 6C, while the calculation circuit into which any LMEM variable is input is fixed regardless of the shift value, the calculation circuit into which any TMEM variable is input is changed in accordance with the shift value. The change of the calculation circuit into which any TMEM variable is input is realized by using, for example, a rotator that operates in accordance with the shift value. Incidentally, the calculation circuit into which any LMEM variable is input can also be changed in accordance with the shift value.

LMEM variables are stored in a variable node storage unit (LMEM) shown in FIGS. 6A, 6B, and 6C. LMEM variables are managed based on the column address. TMEM variables are stored in a check node storage unit (TMEM) shown in FIGS. 6A, 6B, and 6C. TMEM variables are managed based on the row address. The rotator shown in FIGS. 6A, 6B, and 6C inputs eight TMEM variables T0, . . . , T7 from TMEM and rotates these variables in accordance with the shift value of the valid block to be processed. Each of calculation circuits ALU0, . . . , ALU7 shown in FIGS. 6A, 6B, and 6C inputs the corresponding LMEM variable from LMEM and the corresponding rotated TMEM variable from the rotator.

When the shift value=0, as exemplified in FIGS. 5A and 6A, rotate processing of the rotate value=0 is performed on TMEM variables. The rotate processing of the rotate value=0 is equivalent to performing no rotate processing. Therefore, ALU1 inputs the LMEM variable L0 of the column address=0 and the TMEM variable T0 of the row address=0 and ALU7 inputs the LMEM variable L7 of the column address=7 and the TMEM variable T7 of the row address=7.

When the shift value=1, as exemplified in FIGS. 5B and 6B, rotate processing of the rotate value=1 is performed on TMEM variables. The rotate processing of the rotate value=1 is equivalent to cyclically shifting the row address of a TMEM variable by 1 in a decreasing direction. Therefore, ALU0 inputs the LMEM variable L0 of the column address=0 and the TMEM variable T7 of the row address=7 and ALU7 inputs the LMEM variable L7 of the column address=7 and the TMEM variable T6 of the row address=6.

When the shift value=7, as exemplified in FIG. 6C, rotate processing of the rotate value=7 is performed on TMEM variables. The rotate processing of the rotate value=7 is equivalent to cyclically shifting the row address of a TMEM variable by 7 in a decreasing direction or performing the rotate processing of the rotate value=1 seven times. Therefore, ALU0 inputs the LMEM variable L0 of the column address=0 and the TMEM variable T1 of the row address=1 and ALU7 inputs the LMEM variable L7 of the column address=7 and the TMEM variable T0 of the row address=0.

In general, the rotator needs to perform rotate processing of the rotate value=p−1 at the maximum. If the number of quantization bits of a TMEM variable is “u”, the input/output bit width of the rotator needs to be designed to have u×p bits or more.

Partially parallel processing is generally implemented according to the block-based parallel processing scheme. In the block-based parallel processing scheme, memory access to the LLR stored in LMEM using continuous addresses is performed.

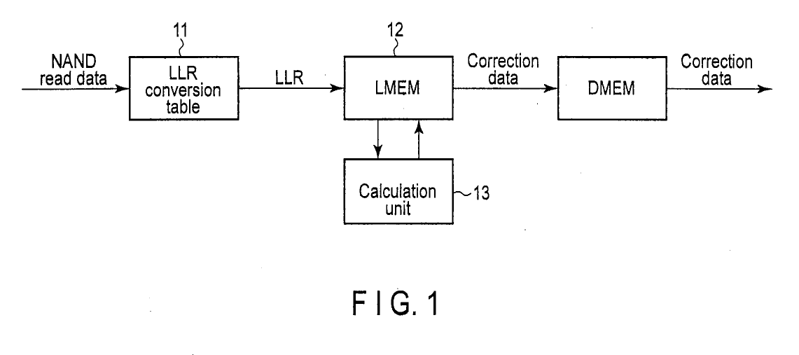

An error correction decoder of the block-based parallel processing scheme is exemplified in FIG. 1. The error correction decoder in FIG. 1 includes an LLR conversion table 11, LMEM 12, a calculation unit 13, and DMEM.

The LLR conversion table 11 inputs ECC (Error Correction Code) frame data corresponding to an LDPC code read from a NAND flash memory (not shown). More specifically, the LLR conversion table 11 sequentially inputs read data of the amount corresponding to the block size in order from the start of the ECC frame data. The LLR conversion table 11 sequentially generates LLR data of the amount corresponding to the block size by converting read data into the LLR. LLR data of the amount corresponding to the block size from the LLR conversion table 11 is sequentially written to the LMEM 12.

The calculation unit 13 reads LLR data (specified by continuous addresses) of the amount corresponding to the block size from the LMEM 12, performs an calculation using the LLR data, and writes an calculation result to the LMEM 12. The calculation unit 13 includes as many calculation circuits as the block size. The calculation unit 13 includes a rotator to perform a calculation in accordance with the shift value of the block. The rotator needs the input/output width of at least the number of quantization bits of the variable to be handled×block size.

After a calculation by the calculation unit 13 is completed, a temporary estimated word based on LLR data is generated at DMEM. If a temporary estimated word satisfies parity checks of all check nodes, correction data corresponding to a data portion of the temporary estimated word is output to a host device (not shown).

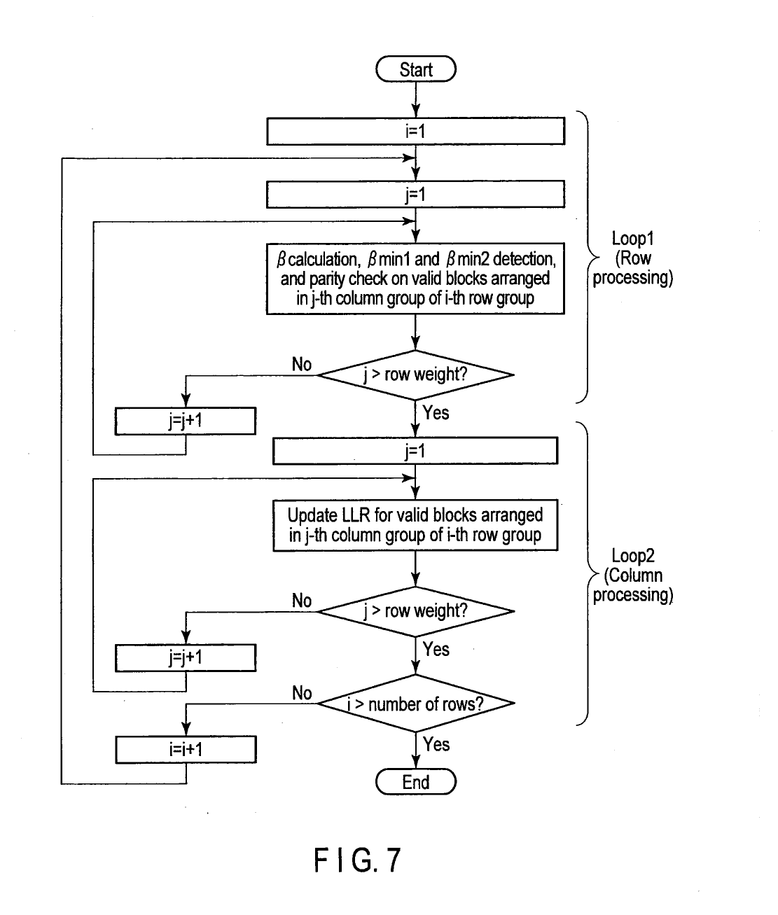

As exemplified in FIG. 7, an error correction decoder of the block-based parallel processing scheme performs row processing and column processing through individual loops. In the description that follows, a row group or a column group means a unit including as many rows or columns as the block size.

In Loop1 (row processing), various calculations are performed in parallel for variable nodes and check nodes belonging to a valid block to be processed. In Loop1, the valid block to be processed moves in a column direction in turn from the first column group of the i-th row group. For example, β for each variable node belonging to the valid block to be processed is calculated by subtracting a added to LLR in column processing of the last iterative decoding of the block from the LLR corresponding to the variable node. β for each variable node is temporarily written to, for example, LMEM. Further, the minimum value βₘᵢₙ₁ and the second smallest value βₘᵢₙ₂ are detected with reference to the absolute value of β for each check node belonging to the valid block to be processed and INDEX as identification information of the variable node providing the βₘᵢₙ₁ is also detected. In addition, the parity check is conducted for each check node belonging to the valid block to be processed. βₘᵢₙ₁, βₘᵢₙ₂, INDEX, and a parity check result for each check node are temporarily written to TMEM. Incidentally, βₘᵢₙ₁, βₘᵢₙ₂, INDEX, and a parity check result for each check node may be updated as processing of valid blocks arranged in the i-th row group progresses. Then, βₘᵢₙ₁, βₘᵢₙ₂, INDEX, and a parity check result for each check node stored in TMEM when processing of all valid blocks arranged in the i-th row group is completed, are used for subsequent column processing.

In Loop2 (column processing), the LLR for each variable node belonging to the valid block to be processed is updated in parallel. Also in Loop2, the valid block to be processed moves in the column direction in turn from the first column group of the i-th row group. More specifically, β for each variable node written to LMEM in row processing of the last iterative decoding is read and βₘᵢₙ₁, βₘᵢₙ₂, INDEX, and a parity check result for each check node are read from TMEM. α is added to β of each variable node and an calculation result is written to LMEM as an updated LLR of the variable node. α added to β of each variable node depends on βₘᵢₙ₁, βₘᵢₙ₂, INDEX, and a parity check result detected in one check node corresponding to the variable node of the valid block to be processed. More specifically, as will be described later, the absolute value of α depends on βₘᵢₙ₁, βₘᵢₙ₂, INDEX, and identification information of the variable node and the sign of α depends on the sign of β and a parity check result.

After the processing in FIG. 7 is completed, a temporary estimated word is generated based on the updated LLR and the parity check is conducted for all check nodes. If the temporary estimated word does not satisfy the parity check, the processing in FIG. 7 is restarted.

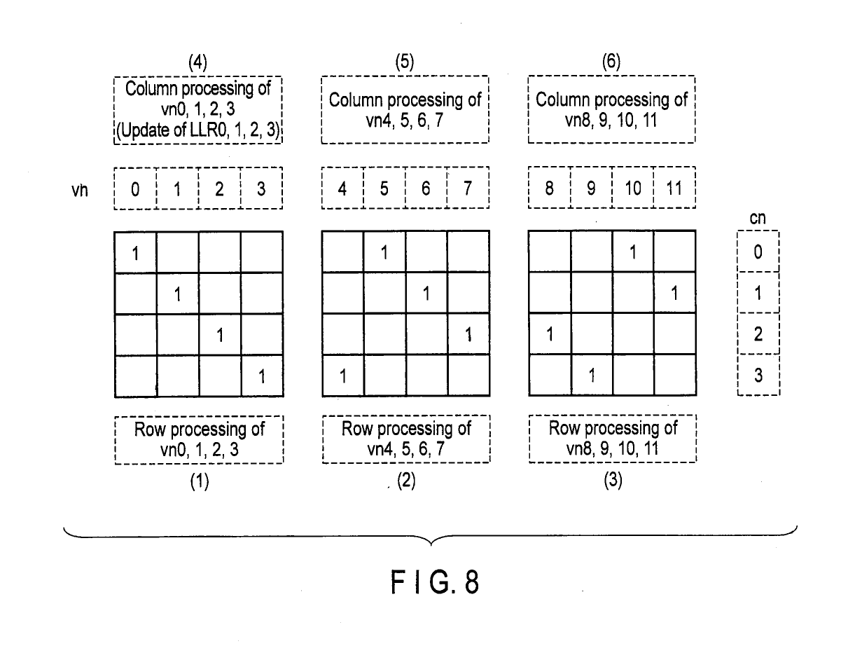

More specifically, according to the block-based parallel processing scheme, row processing and column processing proceed as exemplified in FIG. 8. In the example in FIG. 8, the block size=4, the row size of the parity check matrix is 1 block (=4 rows), and the column size of the parity check matrix is 3 blocks (=12 rows). In this case, the codeword length (used in the same meaning as the frame length in the description that follows) is 12 bits.

In the block-based parallel processing scheme, row processing and column processing cannot be performed in parallel for the same valid block. This is because, for example, before row processing on all valid blocks arranged in a given row group is completed (that is, βₘᵢₙ₁, βₘᵢₙ₂, INDEX, and parity check results of all check nodes belonging to the row group are determined), column processing on any valid block arranged in the row group cannot be started. Therefore, β calculated in row processing needs to be written back to LMEM and access congestion of LMEM is caused, resulting in lower throughput.

Further, when the row size of a parity check matrix is two blocks or more, according to the ordinary block-based parallel processing scheme, it is difficult to perform column processing on a valid block arranged in a given row group and row processing on a valid block arranged in the next row group in parallel. This is because, for example, before column processing on a given valid block arranged in a given row group is completed (that is, the LLR of variable nodes belonging to the valid block is updated), row processing on a valid block arranged in the same column as the valid block in the next row group cannot be started.

Thus, as will be described later, an error correction decoder according to the first embodiment performs column processing on one or more valid blocks arranged in a first row group and row processing on one or more valid blocks arranged in a second row group whose processing order is later than the first row group in parallel by controlling at least one of the write order, read order, and read timing of the LLR or using a parity check matrix having a specific structure.

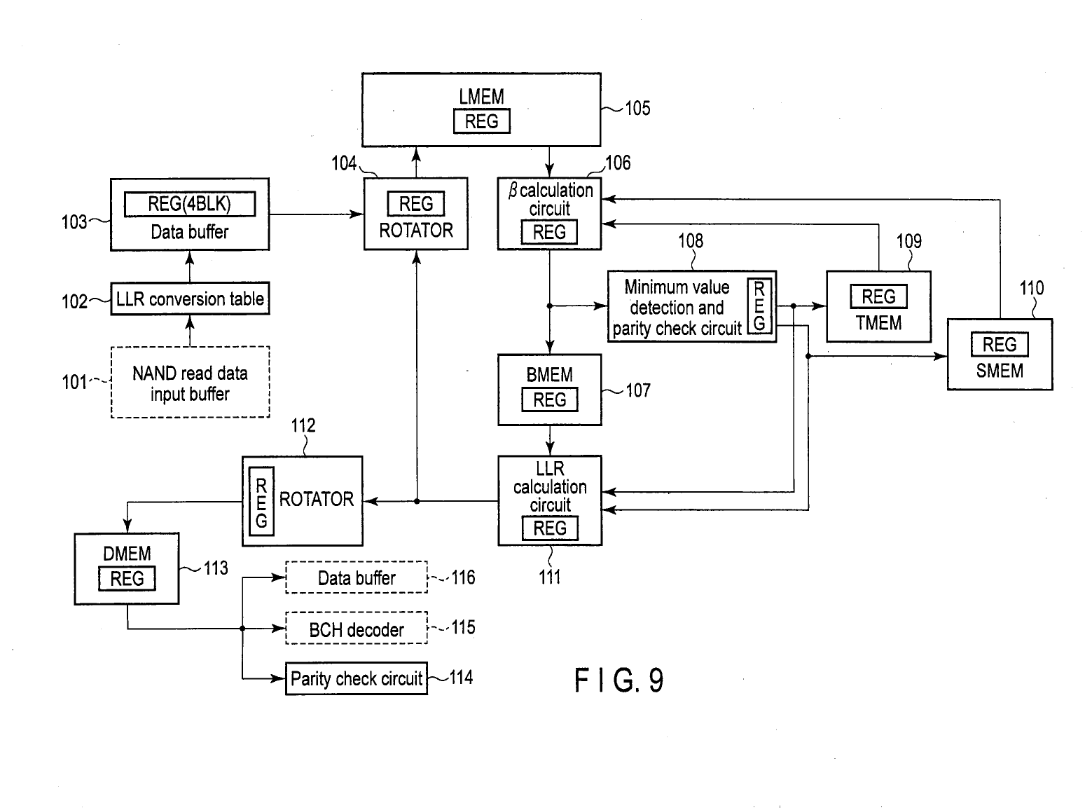

As exemplified in FIG. 9, an error correction decoder according to the present embodiment includes a NAND read data input buffer 101, an LLR conversion table 102, a data buffer 103, a rotator 104, LMEM 105, a β calculation circuit 106, BMEM 107, a minimum value detection and parity check circuit 108, TMEM 109, SMEM 110, an LLR calculation circuit 111, a rotator 112, DMEM 113, a parity check circuit 114, a BCH (Bose-Chaudhuri-Hocquenghem) decoder 115, and a data buffer 116. The degree of parallelism (the number of valid blocks that can be processed simultaneously in one stage) of the error correction decoder in FIG. 9 is 1. However, the degree of parallelism can be increased to 2, 3, or more by increasing the number of functional units by two times, three times, or more.

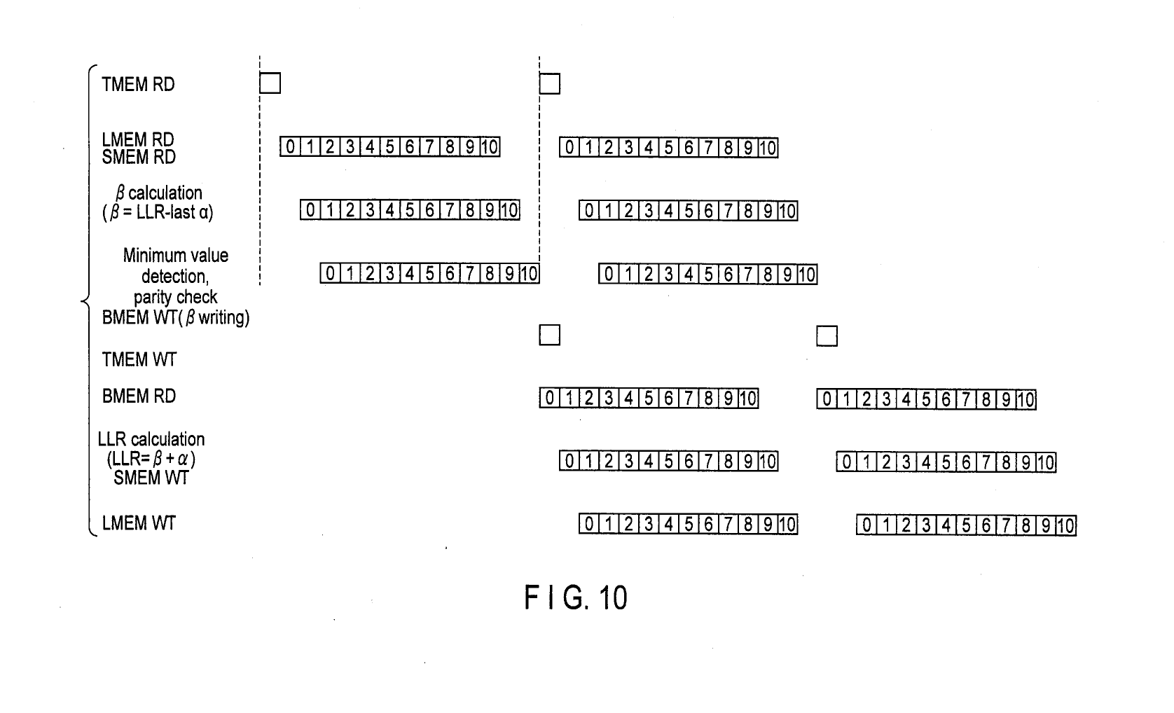

As exemplified in FIG. 10, the error correction decoder in FIG. 9 is designed such that 6-stage pipeline processing can be performed. The execution timing of each stage is controlled by a clock signal (not shown).

In the first stage, the β calculation circuit 106 reads the LLR of variable nodes belonging to n valid blocks from the LMEM 105 and reads the sign of α added to β of these variable nodes in the last column processing on the block from the SMEM 110. n means the aforementioned degree of parallelism. Before starting the second stage for the first valid block of the row group to be processed, the β calculation circuit 106 needs to read βₘᵢₙ₁, βₘᵢₙ₂, and INDEX of all check nodes belonging to the row group from the TMEM 109.

In the second stage, the β calculation circuit 106 calculates β. In the third stage, the β calculation circuit 106 writes β to the BMEM 107. Further, in the third stage, the minimum value detection and parity check circuit 108 detects βₘᵢₙ₁, βₘᵢₙ₂ and INDEX for each check node and also conducts the parity check for each check node. After the third stage is completed for all valid blocks arranged in the row group to be processed, the minimum value detection and parity check circuit 108 writes βₘᵢₙ₁, βₘᵢₙ₂, INDEX, and parity check results of all check nodes of the row group to the TMEM 109 and also outputs βₘᵢₙ₁, βₘᵢₙ₂, INDEX, and parity check results to the LLR calculation circuit 111.

In the fourth stage, the LLR calculation circuit 111 reads β of variable nodes of n valid blocks from the BMEM 107. In the fifth stage, the LLR calculation circuit 111 calculates the LLR. At this point, the minimum value detection and parity check circuit 108 writes the sign of α added to β to the SMEM 110. In the sixth stage, the LLR calculation circuit 111 writes the LLR to the LMEM 105.

The NAND read data input buffer 101 temporarily stores NAND read data from a NAND flash memory (not shown). The NAND read data has, for example, a parity bit added thereto in ECC frame units by an error correction encoder (not shown). The NAND read data input buffer 101 outputs stored NAND read data to the LLR conversion table 102 when necessary.

The LLR conversion table 102 converts NAND read data from the NAND read data input buffer 101 into reliability information (for example, LLR). The correspondence between NAND read data and reliability information is created in advance by, for example, a statistical technique. The LLR converted by the LLR conversion table 102 is written to the data buffer 103.

The data buffer 103 temporarily stores the LLR from the LLR conversion table 102. The LLR stored in the data buffer 103 is written to the LMEM 105 via the rotator 104.

The LMEM 105 stores the LLR from the data buffer 103. The LLR stored in the LMEM 105 is read in n-block units by the β calculation circuit 106 for row processing. Further, the LLR calculation circuit 111 writes the LLR updated through row processing to the LMEM 105 through the rotator 104. Incidentally, the LMEM 105 needs the storage capacity of the number of quantization bits of the codeword length×LLR or more. From the viewpoint of cost optimization, therefore, the LMEM 105 may be implemented by using SRAM.

The β calculation circuit 106 calculates β of each variable node based on the LLR of each variable node read from the LMEM 105 and belonging to the valid block to be processed, βₘᵢₙ₁, βₘᵢₙ₂, and INDEX read from the TMEM 109 and detected in the last row processing of the block, and the sign of α read from the SMEM 110 and used in the last column processing of the block.

More specifically, the β calculation circuit 106 may calculate β of each variable node belonging to the valid block to be processed by subtracting a used in the last column processing of the block from the LLR of the variable node. Incidentally, the absolute value of Nₘᵢₙ₂ is used as the absolute value of α for a variable node having the same identification information as INDEX. On the other hand, the absolute value of βₘᵢₙ₁ is used as the absolute value of a for a variable node having different identification information from INDEX. The β calculation circuit 106 writes calculated β to the BMEM 107 and also outputs the β to the minimum value detection and parity check circuit 108.

The BMEM 107 stores β from the β calculation circuit 106. β stored in the BMEM 107 is read in n-block units processing by the LLR calculation circuit 111 for column.

The minimum value detection and parity check circuit 108 detects the minimum value βₘᵢₙ₁ and the second smallest value βₘᵢₙ₂ with reference to the absolute value of β calculated by the β calculation circuit 106 for each check node belonging to the valid block to be processed and further detects INDEX as identification information of the variable node providing the βₘᵢₙ₁. The minimum value detection and parity check circuit 108 writes βₘᵢₙ₁, βₘᵢₙ₂, and INDEX to the TMEM 109 and also outputs βₘᵢₙ₁, βₘᵢₙ₂, and INDEX to the LLR calculation circuit 111.

The minimum value detection and parity check circuit 108 further uses β calculated by the β calculation circuit 106 to conduct the parity check for each check node belonging to the valid block to be processed. The parity check result is used to decide the sign of α added to β of each variable node corresponding to the check node to be processed. More specifically, the minimum value detection and parity check circuit 108 performs an EX-OR operation using sign bits of all β of check nodes to be processed. If the calculation result is 0, the parity check result is OK and if the calculation result is 1, the parity check result is NG. The minimum value detection and parity check circuit 108 writes the parity check result for each check node to the TMEM 109.

The minimum value detection and parity check circuit 108 further decides the sign of α added to β of each variable node in column processing of the row group to be processed. The sign of α can be decided based on the sign of the corresponding β and the parity check result of the corresponding check node. If, for example, the sign of β is 0 (that is, positive) and the parity check result is OK, the sign of α is also decided to be 0. On the other hand, if the sign of β is 0, but the parity check result is NG, the sign of α is decided to be 1 (that is, negative). If the sign of β is 1 and the parity check result is OK, the sign of α is also decided to be 1. On the other hand, if the sign of β is 1, but the parity check result is NG, the sign of α is decided to be 0.

The minimum value detection and parity check circuit 108 may be implemented as separate minimum value detection and parity check circuits. These separate minimum value detection and parity check circuits may be connected in parallel or connected in series.

The TMEM 109 stores various kinds of intermediate value data from the minimum value detection and parity check circuit 108. Various kinds of intermediate value data include, for example, βₘᵢₙ₁, βₘᵢₙ₂, INDEX, and a parity check result for each check node. Various kinds of intermediate value data stored in the TMEM 109 are read by the β calculation circuit 106 for row processing.

The SMEM 110 stores the sign of α from the minimum value detection and parity check circuit 108. The sign of a stored in the SMEM 110 is read by the β calculation circuit 106 for row processing.

The LLR calculation circuit 111 updates the LLR of each variable node belonging to the valid block to be processed based on β read from the BMEM 107 and βₘᵢₙ₁, βₘᵢₙ₂, INDEX, and the sign of α from the minimum value detection and parity check circuit 108. More specifically, the LLR may also be calculated by adding α to β.

The absolute value of α can be decided based on βₘᵢₙ₁, βₘᵢₙ₂, and INDEX. That is, the absolute value of βₘᵢₙ₂ is used as the absolute value of α for a variable node having the same identification information as INDEX. On the other hand, the absolute value of βₘᵢₙ₁ is used as the absolute value of α for a variable node having different identification information from INDEX.

The LLR calculation circuit 111 writes the updated LLR to the LMEM 105 via the rotator 104 and also writes the updated LLR to the DMEM 113 via the rotator 112.

In the DMEM 113, a sign bit (that is, a temporary estimated word), of the LLR updated by the LLR calculation circuit 111 is stored. The temporary estimated word stored in the DMEM 113 is read by the parity check circuit 114 in each trial of iterative decoding (for example, each time the processing in FIG. 7 terminates).

The parity check circuit 114 conducts the parity check of a temporary estimated word read from the DMEM 113 using a parity check matrix. If a temporary estimated word satisfies parity checks of all check nodes, correction data corresponding to a data portion of the temporary estimated word is output to the host device (not shown) via the data buffer 116. If correction data is encoded according to a BCH code as an outer code, the correction data may be output to the BCH decoder 115. The BCH decoder 115 generates correction data by BCH-decoding input data and outputs the correction data to the host device (not shown) via the data buffer 116.

As exemplified in FIG. 10, an error correction decoder according to the present embodiment performs column processing on 10 valid blocks arranged in the first row group and row processing on 10 valid blocks arranged in the second row group whose processing order is later than that of the first row group in parallel.

To realize such parallel processing, it is necessary to avoid a collision of write access of the LLR to the LMEM 105 accompanying column processing on one or more valid blocks arranged in the first row group and read access of the LLR from the LMEM 105 accompanying row processing on one or more valid blocks arranged in the second row group. That is, it is impossible to perform read and write processing on the LLR of the same variable node at the same time. Further, before write processing of the LLR accompanying column processing on a valid block arranged in a column group of the first row group is completed, it is impossible to start read processing of the LLR accompanying row processing on a valid block arranged in the same column group of the second row group.

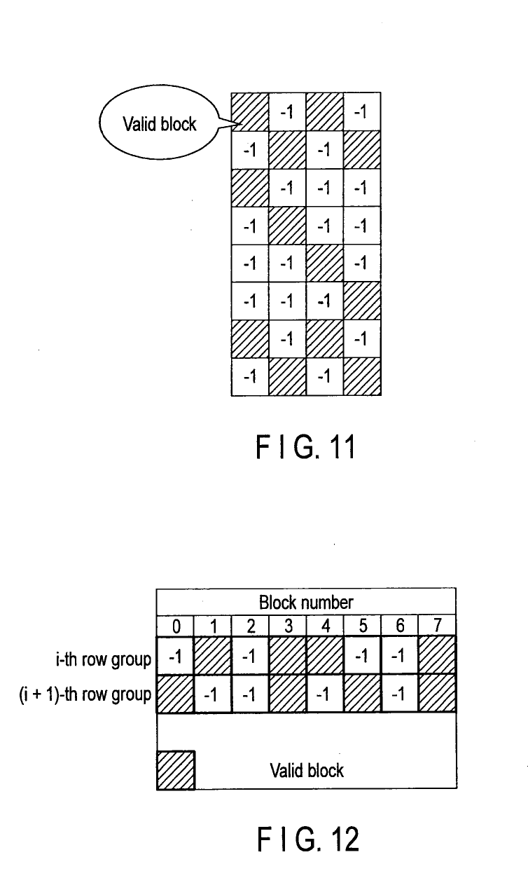

To avoid such an access collision, a restriction described later may be imposed on the structure of a parity check matrix. The restriction may be, for example, to insert at least Z invalid blocks between valid blocks in each column group of the parity check matrix. Z is an integer equal to 1 or greater. In other words, the restriction corresponds to not arranging a plurality of valid blocks consecutively in a row direction in each column group of the parity check matrix. The parity check matrix exemplified in FIG. 11 satisfies this restriction.

If the parity check matrix satisfies this restriction, the column group position of one or more valid blocks intended for column processing in any first row group does not overlap with the column group position of one or more valid blocks intended for row processing in the second row group subsequent to the first row group. Therefore, even if the column processing and the row processing are performed in parallel, a collision of access to the LMEM 105 does not occur.

However, from the viewpoint of implementing an error correction decoder, difficulties of imposing the restriction on a portion (particularly, a parity portion) of the parity check matrix can be expected. Thus, an error correction decoder according to the present embodiment may adaptively perform various kinds of scheduling by a scheduler (not shown).

It is assumed that, as exemplified in FIG. 12, the restriction is not satisfied by a portion of the parity check matrix. More specifically, a valid block is arranged in the third column group of the i-th row group and a valid block is also arranged in the third column group of the (i+1)-th row group. These valid blocks are arranged consecutively in the row direction and thus go against the above restriction. Similarly, a valid block is arranged in the seventh column group of the i-th row group and a valid block is also arranged in the seventh column group of the (i+1)-th row group. These valid blocks are also arranged consecutively in the row direction and thus go against the above restriction.

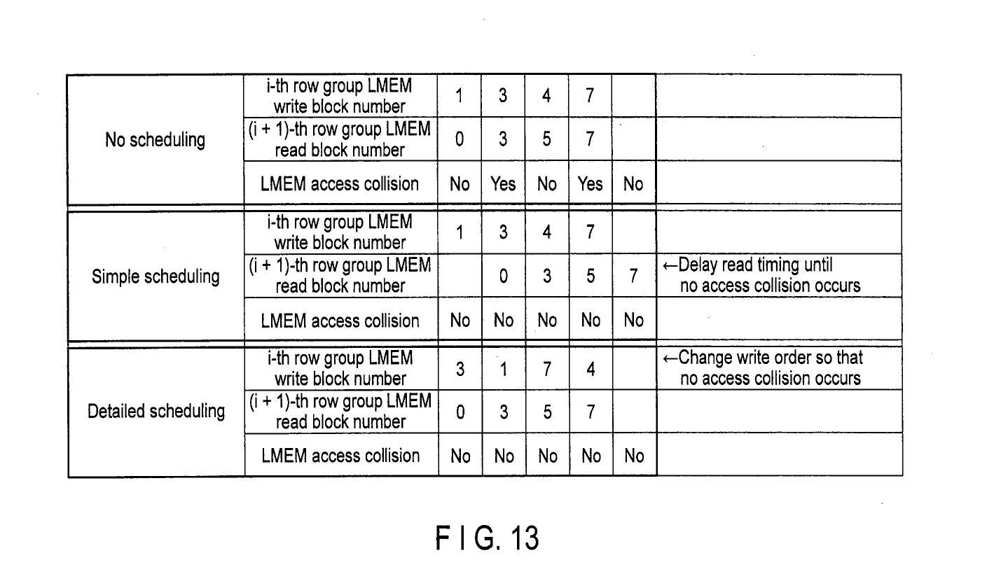

Therefore, if, as exemplified in FIG. 13, no particular scheduling is performed, write access to the LMEM 105 accompanying column processing on the valid block in the third column group of the i-th row group and read access to the LMEM 105 accompanying row processing on the valid block in the third column group of the (i+1)-th row group will collide. Similarly, write access to the LMEM 105 accompanying column processing on the valid block in the seventh column group of the i-th row group and read access to the LMEM 105 accompanying row processing on the valid block in the seventh column group of the (i+1)-th row group will collide. Therefore, column processing on the valid block arranged in the i-th row group and row processing on the valid block arranged in the (i+1)-th row group cannot simply be performed in parallel.

When such an access collision is expected (that is, the column group position of one or more valid blocks arranged in the first row group overlaps with the column group position of one or more valid blocks arranged in the second row group whose processing order is later than that of the first row group), a scheduler (not shown) may perform simple scheduling. The simple scheduling is equivalent to delaying, when compared with the preset timing, the read timing of the LLR corresponding to the variable node belonging to each of one or more valid blocks arranged in the row block intended for row processing until no access collision occurs. The preset timing is, for example, the read timing when no access collision occurs. According to the example in FIG. 13, an access collision is avoided by delaying, when compared with the preset timing, the read timing of the LLR corresponding to the variable node belonging to each valid block arranged in the (i+1)-th row group by one block.

Instead of the simple scheduling or in addition to the simple scheduling, the scheduler may perform detailed scheduling. The detailed scheduling is equivalent to changing (interchanging) the write order of a plurality of valid blocks intended for column processing or the read order of a plurality of valid blocks intended for row processing so as to avoid an access collision.

When an access collision occurs in a valid block arranged in the row group intended for column processing (that is, the column group position of the valid block matches the column group position of one of one or more valid blocks arranged in the row group intended for row processing), the detailed scheduling may including changing the write order of the LLR corresponding to the variable node belonging to the valid block such that the order is earlier than the preset order. The preset order is, for example, the write order when no access collision occurs. According to the example in FIG. 13, the write order when no access collision occurs is the ascending order of the column block number.

In the example of FIG. 13, the write order accompanying column processing on a valid block of the first column group of the i-th row group and the write order accompanying column processing on a valid block of the third column group of the i-th row group are interchanged. Further in the example of FIG. 13, the write order accompanying column processing on a valid block of the fifth column group of the i-th row group and the write order accompanying column processing on a valid block of the seventh column group of the i-th row group are interchanged. As a result, an access collision is avoided. More specifically, column processing on a valid block of the third column group of the i-th row group terminates before row processing on a valid block of the third column group of the (i+1)-th row group starts and column processing on a valid block of the seventh column group of the i-th row group terminates before row processing on a valid block of the seventh column group of the (i+1)-th row group starts.

When an access collision occurs in a valid block arranged in the row group intended for row processing (that is, the column group position of the valid block matches the column group position of one of one or more valid blocks arranged in the row group intended for column processing), the detailed scheduling may including changing the read order of the LLR corresponding to the variable node belonging to the valid block such that the order is later than the preset order. The preset order is, for example, the read order when no access collision occurs. According to the example in FIG. 13, the read order when no access collision occurs is the ascending order of the column block number.

According to the example in FIG. 13, when compared with a case in which column processing on one or more valid blocks arranged in the i-th row group and row processing on one or more valid blocks arranged in the (i+1)-th row group are performed sequentially, the processing speed can be enhanced by about 1.4 to 1.9 times by performing the simple scheduling or the detailed scheduling.

An error correction decoder according to the first embodiment performs, as has been described above, column processing on each of one or more valid blocks arranged in the first row group and row processing on each of one or more valid blocks arranged in the second row group whose processing order is later than that of the first row group in parallel. Therefore, according to the error correction decoder, error correction decoding processing of the block-based parallel processing scheme can be performed at high speed.

Incidentally, the BMEM 107 can be deleted from the error correction decoder in FIG. 9. In such a case, two independent read accesses and two independent write accesses arise in the LMEM 105 at the same time. Therefore, for example, the LMEM 105 needs to be implemented by using 4-port SRAM. The β calculation circuit 106 writes β calculated through row processing to the LMEM 105, instead of the BMEM 107. β stored in the LMEM 105 is read by the LLR calculation circuit ill for column processing.

### Second Embodiment

LMEM contained in an error correction decoder according to the aforementioned first embodiment is typically implemented by using 2- (or 4-) port SRAM capable of processing read access and write access at the same time. From the viewpoint of cost reduction, however, implementation of LMEM using 1-port SRAM may be desired.

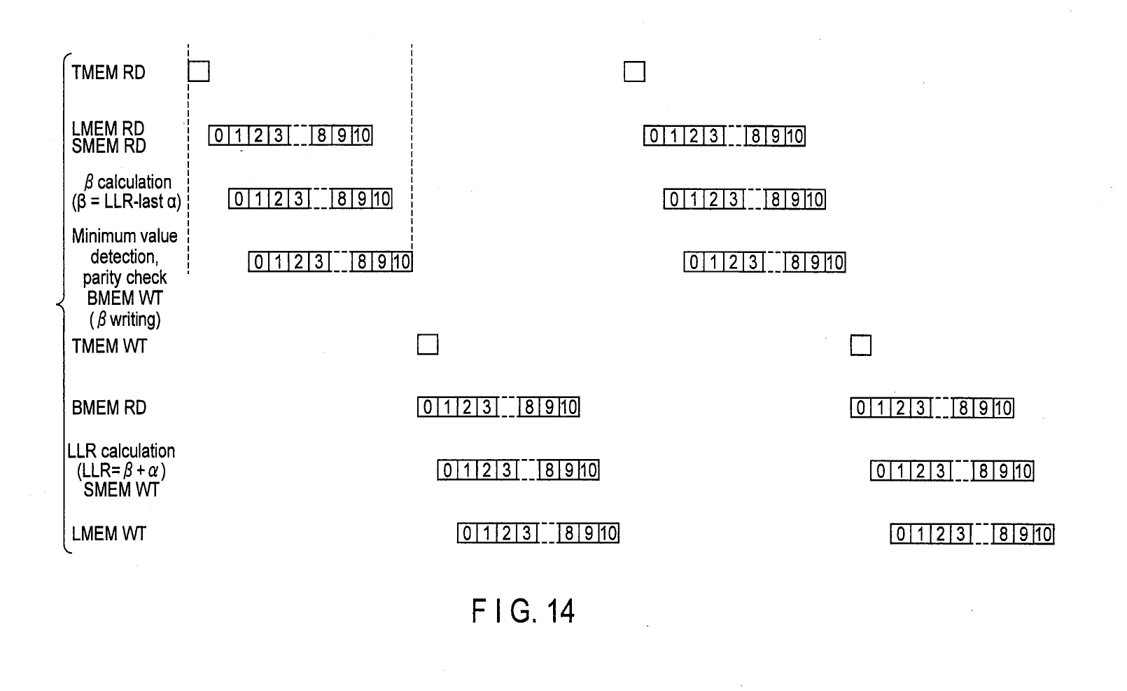

An error correction decoder exemplified in FIG. 9 includes BMEM 107 for reading/writing β. Thus, LMEM 105 can be implemented by using 1-port SRAM. In this case, however, as exemplified in FIG. 14, column processing on one or more valid blocks arranged in the first row group and row processing on one or more blocks arranged in the second row group whose processing order is later than that of the first row group need to be performed sequentially.

An error correction decoder according to the second embodiment includes, as has been described above, BMEM for reading/writing β and also performs column processing on each of one or more valid blocks arranged in the first row group and row processing on each of one or more valid blocks arranged in the second row group whose processing order is later than that of the first row group sequentially. Therefore, according to the error correction decoder, LMEM can be implemented by using 1-port SRAM without loss of the speed of error correction decoding processing of the block-based parallel processing scheme.

At least a portion of processing in each of the above embodiments can be realized by using a general-purpose computer as basic hardware. A program to realize the processing in each of the above embodiments may be provided by being stored in a computer readable storage medium. The program is stored in the storage medium as a file in an installable format or a file in an executable format. The storage medium includes a magnetic disk, an optical disk (CD-ROM, CD-R, DVD and the like), a magneto-optical disk (MO and the like), and a semiconductor memory. Any storage medium that can store a program and can be read by a computer may be used. In addition, the program to realize the processing of each of the above embodiments may be stored on a computer (server) connected to a network such as the Internet to allow a computer (client) to download the program via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An error correction decoder, comprising:
a first storage unit configured to store first reliability information of each of a plurality of bits corresponding to an ECC (Error Correction Code) frame defined by a parity check matrix in which M×N (M and N are integers equal to 2 or greater) blocks are arranged, each of the blocks corresponding to either an invalid block as a zero matrix of p rows×p columns (p is an integer equal to 2 or greater) or a valid block as a nonzero matrix of p rows×p columns;
a second storage unit configured to store second reliability information of each of the plurality of bits;
a first calculation circuit configured to read the first reliability information corresponding to variable nodes belonging to each of one or more valid blocks arranged in a given row group of the parity check matrix from the first storage unit, to calculate the second reliability information corresponding to the variable nodes by performing row processing based on the first reliability information, and to write the second reliability information to the second storage unit; and
a second calculation circuit configured to read the second reliability information corresponding to variable nodes belonging to each of the one or more valid blocks arranged in the given row group of the parity check matrix from the second storage unit, to calculate the first reliability information corresponding to the variable nodes by performing column processing based on the second reliability information, and to write the first reliability information to the first storage unit, wherein
the first calculation circuit and the second calculation circuit perform the column processing based on the second reliability information corresponding to variable nodes belonging to each of one or more valid blocks arranged in a first row group and the row processing based on the first reliability information corresponding to variable nodes belonging to one or more valid blocks arranged in a second row group whose processing order is later than that of the first row group in parallel.

2. The decoder according to claim 1, further comprising a scheduler configured to, when a column group position of the one or more valid blocks arranged in the first row group overlaps with that of the one or more valid blocks arranged in the second row group, change at least one of (a) a write order of the first reliability information corresponding to variable nodes belonging to each of the one or more valid blocks arranged in the first row group, (b) a read order of the first reliability information corresponding to variable nodes belonging to each of the one or more valid blocks arranged in the second row group, and (c) a read timing of the first reliability information corresponding to variable nodes belonging to each of the one or more valid blocks arranged in the second row group.

3. The decoder according to claim 2, wherein the scheduler changes, when the column group position of a first variable block contained in the one or more valid blocks arranged in the first row group matches that of any of the one or more valid blocks arranged in the second row group, the write order of the first reliability information corresponding to variable nodes belonging to the first valid block so as to be earlier than a preset order.

4. The decoder according to claim 2, wherein the scheduler changes, when the column group position of a second variable block contained in the one or more valid blocks arranged in the second row group matches that of any of the one or more valid blocks arranged in the first row group, the read order of the first reliability information corresponding to variable nodes belonging to the second valid block so as to be later than a preset order.

5. The decoder according to claim 2, wherein the scheduler delays, when the column group position of the one or more valid blocks arranged in the first row group overlaps with that of the one or more valid blocks arranged in the second row group, the read timing of the first reliability information corresponding to variable nodes belonging to each of the one or more valid blocks arranged in the second row group when compared with a preset timing.

6. The decoder according to claim 1, wherein one or more invalid blocks are inserted between valid blocks arranged in each column group of the parity check matrix.

7. An error correction decoder, comprising:
a storage unit configured to store first reliability information and second reliability information of each of a plurality of bits corresponding to an ECC (Error Correction Code) frame defined by a parity check matrix in which M×N (M and N are integers equal to 2 or greater) blocks are arranged, each of the blocks corresponding to either an invalid block as a zero matrix of p rows×p columns (p is an integer equal to 2 or greater) or a valid block as a nonzero matrix of p rows×p columns;
a first calculation circuit configured to read the first reliability information corresponding to variable nodes belonging to each of one or more valid blocks arranged in a given row group of the parity check matrix from the storage unit, to calculate the second reliability information corresponding to the variable nodes by performing row processing based on the first reliability information, and to write the second reliability information to the storage unit; and
a second calculation circuit configured to read the second reliability information corresponding to variable nodes belonging to each of the one or more valid blocks arranged in the given row group of the parity check matrix from the storage unit, to calculate the first reliability information corresponding to the variable nodes by performing column processing based on the second reliability information, and to write the first reliability information to the storage unit, wherein
the first calculation circuit and the second calculation circuit perform the column processing based on the second reliability information corresponding to variable nodes belonging to each of one or more valid blocks arranged in a first row group and the row processing based on the first reliability information corresponding to variable nodes belonging to one or more valid blocks arranged in a second row group whose processing order is later than that of the first row group in parallel.

8. The decoder according to claim 7, further comprising a scheduler configured to, when a column group position of the one or more valid blocks arranged in the first row group overlaps with that of the one or more valid blocks arranged in the second row group, change at least one of (a) a write order of the first reliability information corresponding to variable nodes belonging to each of the one or more valid blocks arranged in the first row group, (b) a read order of the first reliability information corresponding to variable nodes belonging to each of the one or more valid blocks arranged in the second row group, and (c) a read timing of the first reliability information corresponding to variable nodes belonging to each of the one or more valid blocks arranged in the second row group.

9. The decoder according to claim 8, wherein the scheduler changes, when the column group position of a first variable block contained in the one or more valid blocks arranged in the first row group matches that of any of the one or more valid blocks arranged in the second row group, the write order of the first reliability information corresponding to variable nodes belonging to the first valid block so as to be earlier than a preset order.

10. The decoder according to claim 8, wherein the scheduler changes, when the column group position of a second variable block contained in the one or more valid blocks arranged in the second row group matches that of any of the one or more valid blocks arranged in the first row group, the read order of the first reliability information corresponding to variable nodes belonging to the second valid block so as to be later than a preset order.

11. The decoder according to claim 8, wherein the scheduler delays, when the column group position of the one or more valid blocks arranged in the first row group overlaps with that of the one or more valid blocks arranged in the second row group, the read timing of the first reliability information corresponding to variable nodes belonging to each of the one or more valid blocks arranged in the second row group when compared with a preset timing.

12. The decoder according to claim 7, wherein one or more invalid blocks are inserted between valid blocks arranged in each column group of the parity check matrix.

13. An error correction decoder, comprising:
a first storage unit configured to be implemented by using 1-port SRAM (Static Random Access Memory) to store first reliability information of each of a plurality of bits corresponding to an ECC (Error Correction Code) frame defined by a parity check matrix in which M×N (M and N are integers equal to 2 or greater) blocks are arranged, each of the blocks corresponding to either an invalid block as a zero matrix of p rows×p columns (p is an integer equal to 2 or greater) or a valid block as a nonzero matrix of p rows×p columns;
a second storage unit configured to store second reliability information of each of the plurality of bits;
a first calculation circuit configured to read the first reliability information corresponding to variable nodes belonging to each of one or more valid blocks arranged in a given row group of the parity check matrix from the first storage unit, to calculate the second reliability information corresponding to the variable nodes by performing row processing based on the first reliability information, and to write the second reliability information to the second storage unit; and
a second calculation circuit configured to read the second reliability information corresponding to variable nodes belonging to each of the one or more valid blocks arranged in the given row group of the parity check matrix from the second storage unit, to calculate the first reliability information corresponding to the variable nodes by performing column processing based on the second reliability information, and to write the first reliability information to the first storage unit, wherein
the first calculation circuit and the second calculation circuit perform the column processing based on the second reliability information corresponding to variable nodes belonging to each of one or more valid blocks arranged in a first row group and the row processing based on the first reliability information corresponding to variable nodes belonging to one or more valid blocks arranged in a second row group whose processing order is later than that of the first row group sequentially.
